(19) United States
(12) Patent Application Publication
(10) Pub. No.: US 2013/0146464 A1
(43) Pub. Date: Jun. 13, 2013

(54) ELECTROMAGNETIC FIELD TREATMENT METHOD FOR WATER, ELECTROMAGNETIC FIELD TREATMENT DEVICE FOR WATER, AND ELECTROMAGNETIC FIELD TREATMENT DEVICE

(71) Applicant: SHIGA FUNCTIONAL WATER LABORATORY CORPORATION, Sagamihara-shi (JP)

(72) Inventor: Seiki SHIGA, Sagamihara-shi (JP)

(73) Assignee: SHIGA FUNCTIONAL WATER LABORATORY CORPORATION, Sagamihara-shi (JP)

(21) Appl. No.: 13/765,248

(22) Filed: Feb. 12, 2013

Related U.S. Application Data
(63) Continuation-in-part of application No. PCT/JP2011/068377, filed on Aug. 11, 2011.

(30) Foreign Application Priority Data
Aug. 13, 2010 (JP) 2010-181446

(51) Int. Cl. C02F 1/48

(52) U.S. Cl. CPC C02F 1/487
USPC 204/557; 204/663

(57) ABSTRACT

An electromagnetic field treatment method for water includes applying, to water, an alternating magnetic field generated by applying an alternating current to a coil, and applying, to the water, an alternating electric field generated by applying an alternating voltage in synchronization with the alternating magnetic field to an electrode, wherein the alternating current has a rectangular alternating current wave, and the alternating voltage at rise time of an alternating wave of the alternating magnetic field has a high level, whereas the alternating voltage at fall time of the alternating wave of the alternating magnetic field has a low level, or the alternating voltage at the rise time of the alternating magnetic field has a low level, whereas the alternating voltage at the fall time of the alternating magnetic field has a high level.

### CROSS-REFERENCE TO RELATED APPLICATION

This application is a continuation-in-part (CIP) application based upon the International Application PCT/JP2011/68377, the International Filing Date of which is Aug. 11, 2011, the entire content of which is incorporated herein by reference, and claims the benefit of priority from the prior Japanese Patent Application No. 2010-181446, filed in the Japanese Patent Office on Aug. 13, 2010, the entire content of which is incorporated herein by reference.

### FIELD

Embodiments described herein relate generally to an electromagnetic field treatment method for water, an electromagnetic field treatment device for water, and an electromagnetic field treatment device.

### BACKGROUND

It is known that water is subjected to electromagnetic field treatments to aim for improvements in water function. JP-A2008-290053 (KOKAI) discloses an induced electromagnetic field which is applied to water by applying an electric current of specific frequency to a coil wound around a water pipe.

However, the mere application of the induced electromagnetic field to water results, in many cases, in a small electromagnetic field treatment effect depending on the temperature, etc. of the water, and has the drawback of lacking the stability of the electromagnetic treatment effect.

### BRIEF DESCRIPTION OF THE DRAWINGS

FIG. 1 is an example of an electromagnetic field treatment device according to an embodiment;

FIG. 2 is an example of an electromagnetic field treatment device according to an embodiment;

FIG. 3 is waveforms showing an alternating magnetic field according to an embodiment and an induced electromotive force generated by the alternating magnetic field;

FIG. 4A is an example of waveforms of an alternating magnetic field and of an alternating-current voltage (electric field) according to an embodiment;

FIG. 4B is an example of waveforms of an alternating magnetic field and of an alternating-current voltage (electric field) according to an embodiment;

FIG. 4C is an example of waveforms of an alternating magnetic field and of an alternating-current voltage (electric field) according to an embodiment;

FIG. 4D is an example of waveforms of an alternating magnetic field and of an alternating-current voltage (electric field) according to an embodiment;

FIG. 4E is an example of waveforms of an alternating magnetic field and of an alternating-current voltage (electric field) according to an embodiment;

FIG. 4F is an example of waveforms of an alternating magnetic field and of an alternating-current voltage (electric field) according to an embodiment;

FIG. 5 is an example of a solvent characteristic evaluation apparatus;

FIG. 6 is a graph showing results of Example 1 and Comparative Example 1;

FIG. 7 is a graph showing results of Example 2 and Reference Example 1;

FIG. 8A is an example of waveforms of an alternating magnetic field and of an alternating electric field according to a comparative example;

FIG. 8B is an example of waveforms of an alternating magnetic field and of an alternating electric field according to a comparative example;

FIG. 8C is an example of waveforms of an alternating magnetic field and of an alternating electric field according to a comparative example;

FIG. 9 is a graph showing results of Example 6 and Comparative Example 5;

FIG. 10 is a graph showing results of Example 7 and Comparative Example 6;

FIG. 11 is a graph showing results of Example 8 and Comparative Example 7;

FIG. 12 is a graph showing results of Example 9 and Comparative Example 8; and

FIG. 13 is a graph showing results of Example 10 and Comparative Example 9.

### DETAILED DESCRIPTION

An electromagnetic field treatment method for water of an embodiment includes applying, to water, an alternating magnetic field generated by applying an alternating current to a coil, and applying, to the water, an alternating electric field generated by applying an alternating voltage in synchronization with the alternating magnetic field to an electrode. The alternating current and voltage has a rectangular alternating current wave. The alternating voltage at rise time of an alternating wave of the alternating magnetic field has a high level, whereas the alternating voltage at fall time of the alternating wave of the alternating magnetic field has a low level, or the alternating voltage at the rise time of the alternating magnetic field has a low level, whereas the alternating voltage at the fall time of the alternating magnetic field has a high level.

An electromagnetic field treatment device for water of an embodiment at least includes a tube through which water is run, a positive electrode provided on a surface of the tube, a first insulating material covering at least the positive electrode, a negative electrode provided on a surface of the tube or the first insulating material, a coil wound around at least the negative electrode, and an external circuit connected to the positive electrode and the negative electrode as well as the coil. The external circuit is designed to apply an alternating magnetic field and an alternating electric field in synchronization with the alternating magnetic field to the inside of the tube.

An electromagnetic field treatment device of an embodiment includes a magnetic field application unit configured to apply an alternating magnetic field to water, and an electric field application unit configured to apply an alternating electric field in synchronization with the alternating magnetic field to the water. The alternating current and voltage has a rectangular alternating wave. The alternating voltage at rise time of the alternating magnetic field has a high level, whereas the alternating voltage at fall time of the alternating magnetic field has a low level, or the alternating voltage at the rise time of the alternating magnetic field has a low level, whereas the alternating voltage at the fall time of the alternating magnetic field has a high level.

Embodiments of the invention will be described below with reference to the drawings.

(Electromagnetic Field Treatment)

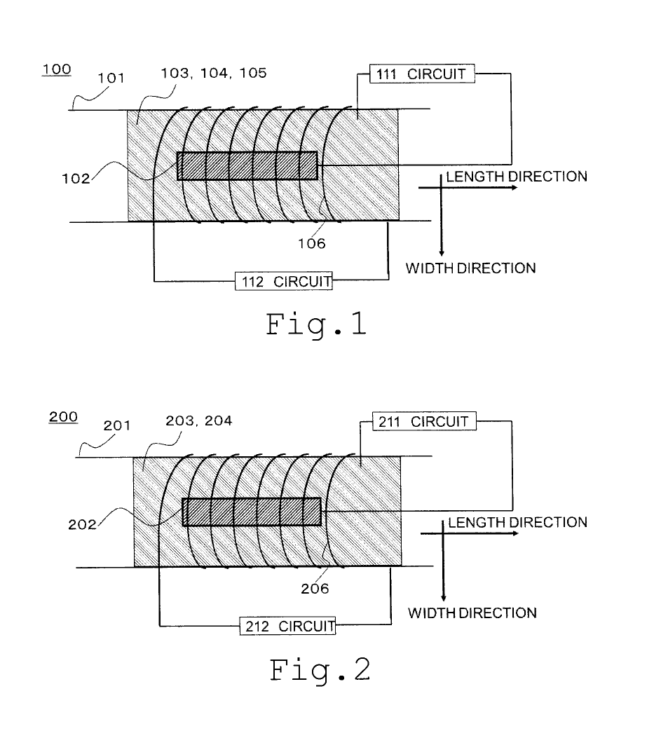

In the present embodiment, an electromagnetic field treatment applied to water with the use of a first electromagnetic field treatment device 100 shown in the conceptual diagram of FIG. 1 will be described.

The first electromagnetic field treatment device includes a tube 101 through which water is run, and a positive electrode 102 is, for example, covered 30 to 50% in width of the tube 101 surface circumference.

further, at least includes a first insulating material 103 covering at least the positive electrode, a negative electrode 104 provided on the surface of the tube 101 through which water is run or the first insulating material 103, a second insulating material 105 covering at least the negative electrode 104, a circuit 111 connected to a coil 106 wound around the tube wrapped with the second insulating material 105, and a circuit 112 connected to the positive electrode 102 and the negative electrode 104 as well as the coil 106.

The circuits 111 and 112 may be either circuits configured on one substrate, or circuits configured on separate substrates. In addition, the circuits 111 and 112 may be either self-powered or externally powered.

For the tube 101 through which water is run, a tube obtained from a dielectric as a material can be used, such as, for example, a vinyl chloride tube (PVC tube), a polyethylene tube, and an FRP tube.

The positive electrode 102 and the negative electrode 104 may be materials which are commonly used as conductive materials or electrode materials.

The coil 106 may be any material which is commonly used as a coil material.

The first and second insulating materials may be any insulators each covering the electrode. For the insulators, articles which are commonly used as insulating materials can be used, such as insulating tapes and heat-shrinkable tubes.

The external circuit 111 and the power source 112 may have any configuration for applying specific alternating-current voltage waves to the electrodes 102 and 104 and the coil 106. For the external circuit, circuits can be used which are configured with the use of discrete circuits, ICs, etc.

It is to be noted that the external circuit is designed so as to apply an alternating magnetic field and an alternating electric field in synchronization with the alternating magnetic field to the inside of the tube through which water is run.

It is to be noted that the water encompasses water containing impurities and water with a solute dissolved therein, and besides, a solution partially containing water, such as, for example, oil.

The electromagnetic field treatment device according to the present embodiment may have a configuration other than the electromagnetic field treatment device 100 in FIG. 1. Specifically, examples of the configuration include a configuration which is able to apply an alternating magnetic field to water and apply an alternating electric field to the alternating magnetic field. The alternating magnetic field at least partially orthogonal to the alternating electric field preferably improves the effect of the electromagnetic field treatment.

This electromagnetic field treatment method includes applying an alternating magnetic field to water and applying an alternating electric field in synchronization with the alternating magnetic field to the water. The alternating current has a rectangular alternating current wave. The alternating voltage at the rise time of the alternating magnetic field has a high level, whereas the alternating voltage at the fall time of the alternating magnetic field has a low level, or the alternating voltage at the rise time of the alternating magnetic field has a low level, whereas the alternating voltage at the fall time of the alternating magnetic field has a high level.

This electromagnetic field treatment device includes: a magnetic field application unit configured to apply an alternating magnetic field to water, and an electric field application unit configured to apply an alternating electric field in synchronization with the alternating magnetic field to the water. The alternating current has a rectangular alternating current wave. The alternating voltage at the rise time of the alternating magnetic field has a high level, whereas the alternating voltage at the fall time of the alternating magnetic field has a low level, or the alternating voltage at the rise time of the alternating magnetic field has a low level, whereas the alternating voltage at the fall time of the alternating magnetic field has a high level.

The alternating magnetic field in the magnetic field treatment for water preferably has a main magnetic flux, and when the magnetic field treatment is carried out for water included in a metallic container, an alternating magnetic field may be applied with the use of a leakage flux generated by an eddy current induced by applying an electric current to the coil, while the main magnetic flux of a magnetic field applied from the outside of the container fails to reach the water included in the container. The magnetic field of the leakage flux is weak as compared with the magnetic field of the main magnetic flux, and the electromagnetic field treatment is preferably carried out on a continuous basis.

Next, a second electromagnetic field treatment device 200 shown in the conceptual diagram of FIG. 2 will be described. The difference from the first electromagnetic field treatment device is that a coil is wound around a negative electrode with the second insulating material omitted, because of the use of a conductive adhesion tape for a positive electrode 202 and a negative electrode 204 and the use of a conductor coated with an insulating material for a coil 206.

In addition to the second electromagnetic field treatment device, electromagnetic field treatment devices in forms adapted to have an equivalent circuit configuration are included in the electromagnetic field treatment device according to the present embodiment.

Next, specific alternating current pulses will be described.

In the present embodiment, an alternating voltage is applied to the electrodes 102 and 104, whereas an alternating current is applied to the coil 106. An alternating magnetic field is generated by applying the electric current to the coil 106. Then, the alternating voltage and the alternating magnetic field are able to change the solvent characteristics of water in a stable manner when all of the conditions described below are satisfied:

the alternating current applied to the coil has a rectangular alternating-current wave; and

the alternating voltage at the rise time of the alternating magnetic field has a high level, whereas the alternating voltage at the fall time of the alternating magnetic field has a low level, or the alternating-voltage at the rise time of the alternating magnetic field has a low level, whereas the alternating voltage at the fall time of the alternating magnetic field has a high level.

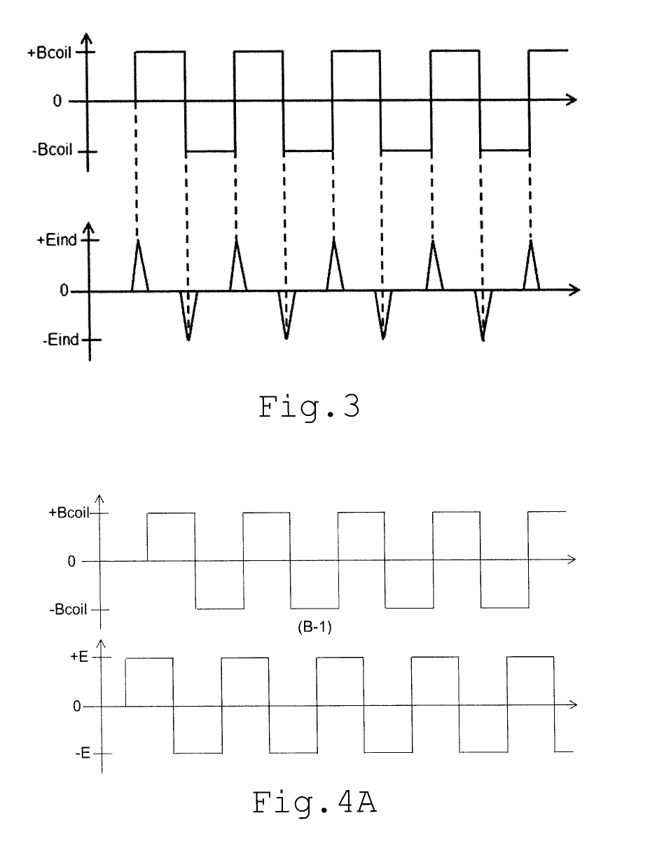

The reason why the high levels and low levels of the waveforms of the alternating magnetic field and alternating voltage need to satisfy the relationship mentioned above will be described based on waveforms indicating an alternating magnetic field and an induced electromotive force generated by the alternating magnetic field in FIG. 3. The dashed lines in the figure are imaginary lines. When an alternating current is applied to the coil to generate the magnetic field in the upper section of FIG. 3, the induced electromotive force generates a spike-like electric potential in the lower section of FIG. 3 in a circumferential direction of the coil. The time to the generation of this spike-like electric potential depends on the rise time of the current applied to the coil. This spike-like voltage is also generated in the water to be subjected to the electromagnetic field treatment, in the tube or the like. The inventor believes that this spike-like electric potential has an effect on clusters of the water. However, this spike-like voltage is approximately 0.01 V to 0.1 V per wound coil, and thus, because of the small effect on the clusters, it is difficult to achieve the effect of the electromagnetic field treatment in a stable manner. Therefore, the inventor has found that such an electric field that compensates this spike-like electric potential is applied to the water to achieve the effect of the electromagnetic field treatment in a stable manner.

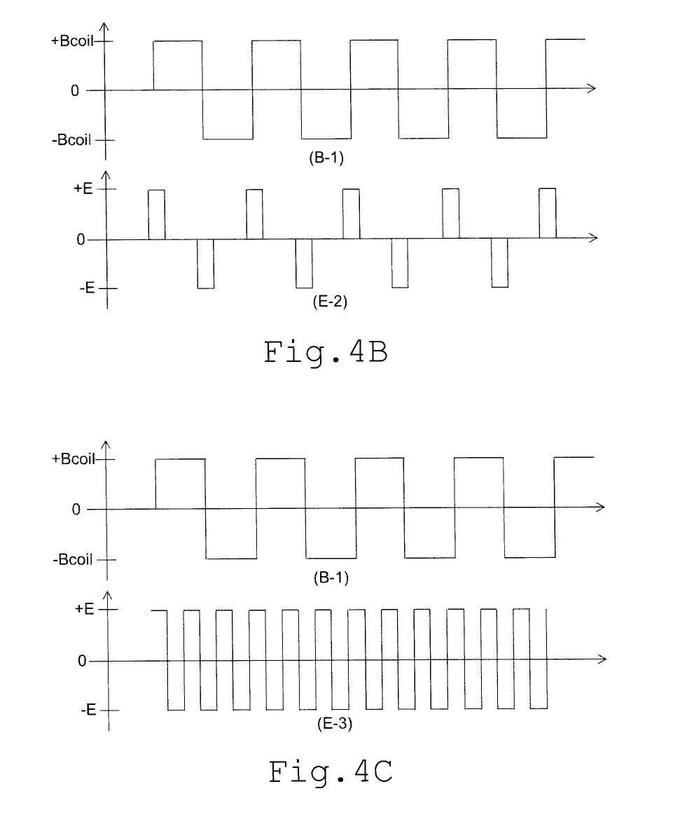

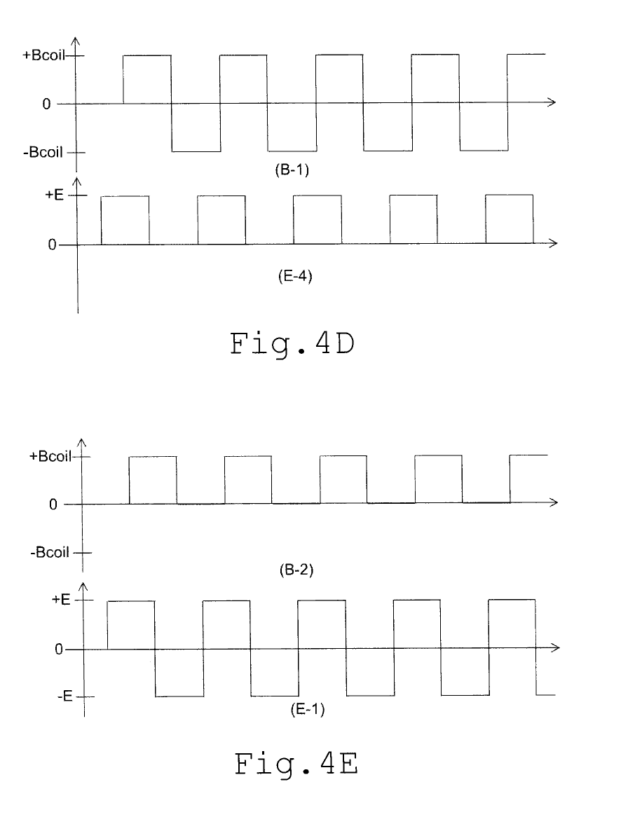

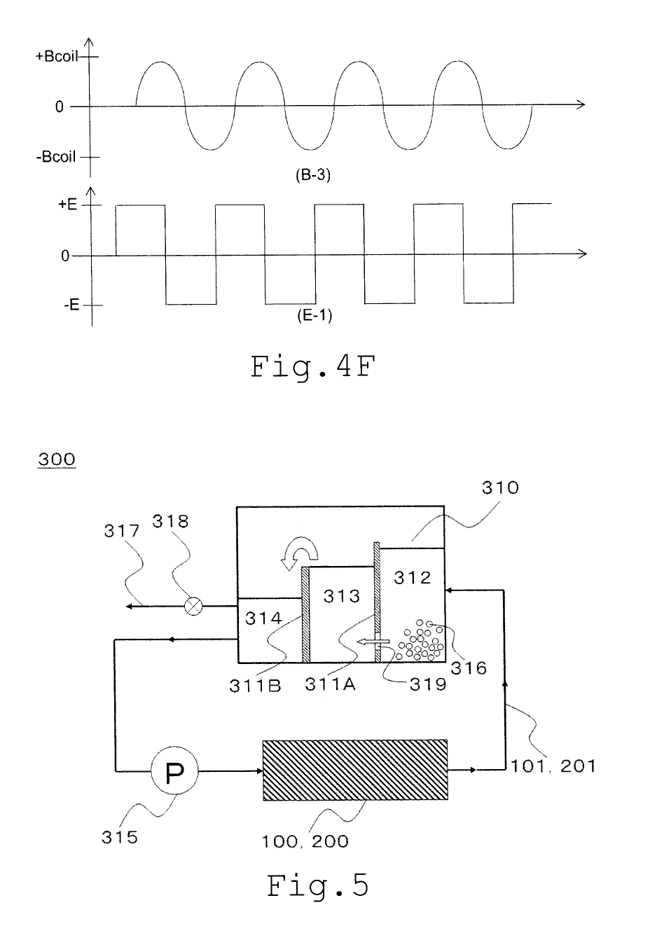

FIG. 4 show examples of waveforms which satisfy the two conditions mentioned above. It is to be noted that the waveform of a magnetic flux density B is the case of applying an electric current to the coil 106.

In FIG. 4A, the alternating magnetic field and the alternating voltage (alternating electric field) have the same frequency, and the waves both have rectangular waves out of phase with each other by 90°.

In FIG. 4B, the alternating magnetic field and the alternating voltage (alternating electric field) have the same frequency, the waves both have rectangular waves out of phase with each other by 90°, and the duty ratio of the alternating electric field is one third of that of the alternating magnetic field.

In FIG. 4C, the frequency of the alternating voltage (alternating electric field) is three times as high as that of the alternating magnetic field, and the waves both have rectangular waves out of phase with each other by 90°.

In FIG. 4D, the alternating magnetic field and the alternating voltage (alternating electric field) have the same frequency, the waves both have rectangular waves out of phase with each other by 90°, and the alternating voltage (alternating electric field) has a minimum voltage of 0 V.

In FIG. 4E, the alternating magnetic field and the alternating voltage (alternating electric field) have the same frequency, the waves both have rectangular waves out of phase with each other by 90°, and the alternating magnetic field has a minimum magnetic flux densities of 0G.

In FIG. 4F, the alternating magnetic field and the alternating voltage (alternating electric field) have the same frequency, and the alternating magnetic field and the alternating voltage (alternating electric field) respectively have a rectangular wave and a sine wave out of phase with each other by 90°.

In addition, the alternating voltage (alternating electric field) and the alternating magnetic field may have different frequencies. The induced electromotive force generated by the speed of the change in magnetic field in water when an electric current is applied to the coil has an effect on the production of electromagnetic water. This induced electromotive force is preferably higher for the production of electromagnetic water, and rectangular waves are thus used for the alternating current wave of the alternating current. For the purpose of compensating this induced electromotive force, an external voltage is applied. Rectangular waves, sine waves, and the like are used for the alternating current wave of the alternating voltage. When the alternating current and the alternating voltage have rectangular waves, the duty ratios of the respective rectangular waves are not particularly limited. It is to be noted that the rise time and the fall time respectively refers to periods of time during which the alternating wave signal reaches 10% to 90% of the high level and low level.

(Alternating Voltage Alternating Magnetic Field)

The alternating current (alternating magnetic field) and alternating voltage according to the present embodiment may have the same frequency, or different frequencies. However, the alternating magnetic field and the alternating current are required to be mutually synchronized. When the alternating current (alternating magnetic field) and the alternating voltage have the same frequency, what is required is only that the respective alternating-current and voltage waves out of phase with each other satisfy the conditions mentioned above. Examples (different frequencies) of the frequencies of the alternating current (alternating magnetic field) and alternating-current voltage which satisfy the conditions include the alternating current (alternating magnetic field) which has an odd multiple of the frequency of the alternating voltage, where the both frequencies have the same duty ratio.

The frequencies of the alternating current (alternating magnetic field) and alternating voltage according to the present embodiment include, for example, 50 Hz or higher and 1 MHz or lower. Above all, the frequencies mentioned in JP 2008-006433 A are preferred, such as, for example, 4.725 kHz. However, the electromagnetic field treatment according to the present embodiment can improve the solvent characteristics of water even at frequencies other than as mentioned in JP 2008-006433 A.

It is to be noted that the preferred frequencies mentioned in JP 2008-006433 A include 151.5 Hz, 205.0 Hz, 222.5 Hz, 301.0 Hz, 345.0 Hz, 466.0 Hz, 484 Hz, 655 Hz, 954 Hz, 1.29 kHz, 3.5 kHz, 4.73 kHz, 7.0 kHz, 9.47 kHz, 20.0 kHz, 27.0 kHz, 37.3 kHz, 50.4 kHz, 80.0 kHz, and 108.0 kHz, and neighborhood frequencies thereof. Besides these frequencies, the preferred frequencies have been also found to include 74.75 Hz which is about half of 151.5 Hz and 102.5 Hz which is half of 205.0 Hz. The frequencies of the alternating current waves in the electromagnetic field treatment refer to frequencies within an error range of ±5%, more preferably within an error range of ±2%, and more preferably within an error range of ±1.5% from these frequencies.

The frequency of the alternating voltage wave (alternating electric field) is determined by the frequency of the alternating current (alternating magnetic field) and the conditions mentioned above. Accordingly, the frequency of the alternating voltage is an odd multiple of the frequency of the alternating current from the frequencies mentioned above. The difference in frequency between the alternating voltage and the alternating current is not preferred because the effect of the electromagnetic field treatment is decreased by the alternating magnetic field and alternating electric field gradually out of synchronization with each other due to the difference in frequency. Thus, the frequency of the alternating voltage is preferably an odd multiple of the same frequency as the frequency of the alternating current as much as possible. It is to be noted that the external circuit or the like according to the present embodiment may be provided with a configuration for resynchronization such as detecting the alternating magnetic field and alternating electric field out of synchronization and resetting the operation.

While the effect of the electromagnetic field treatment according to the present embodiment varies depending on the frequencies, the pronounced effect can be confirmed within a range of ±5%. Other than the foregoing, as a method for measuring preferred frequencies, the frequencies may be measured while shifting the frequencies, and determined appropriately in accordance with the conditions for implementation in the electromagnetic field treatment according to the present embodiment.

In addition, in the case of carrying out the electromagnetic field treatment in an electromagnetic cooker, frequencies of 15 kHz or higher are preferred among the frequencies mentioned above, so as to make it possible to respond to a variety of cookers. The upper limits of the frequencies depend on the frequency for the electromagnetic cooker itself, and thus include, for example, 200 kHz or less and 100 kHz or less.

The peak current of the alternating current according to the present embodiment, for example, from several mA to several A, can be applied to the coil. However, the application of a large electric current dulls the waveform from an alternating current generation circuit, because of limitations on elements in the circuit. The dulled waveform decreases the induced voltage generated in response to the rate of change of the magnetic field, and thus has a tendency to decrease the amount of change in solvent characteristics due to the electromagnetic field treatment. Therefore, the larger electric current is not always a preferred condition.

There is a preferred magnetic field density for a frequency, as described in JP 2008-006433 A. In the case of the frequency of 4.73 kHz, an electric current is preferably applied so as to generate a magnetic field of 188.2 mG, as described in JP 2008-006433 A. The electric current value for achieving the preferred magnetic field density varies depending on the coil and the frequency of the electric current. The present embodiment can improve the solvent characteristics of water even at magnetic flux densities other than as mentioned in JP 2008-006433 A.

Table 1 below shows the values of the frequencies and preferred alternating magnetic flux densities as mentioned in JP 2008-006433 A. Further, Table 1 together lists electric current values for generating magnetic fields with the magnetic flux densities in the table. It is to be noted that the electric current values were calculated from the following formula 1, and the coil turns were adjusted to 454 times (Diameter of Coil Wiring Material: 2.2 mm) and 222 times (Diameter of Coil Wiring Material: 4.2 mm) per 1 m.

B=4π×10⁻⁷×N₀×I (Wb/m²) (Formula 1)

(N₀ refers to coil turns per 1 m)

The electric current values of the alternating current waves in the electromagnetic field treatment refer to electric current value within an error range of ±5%, more preferably within an error range of ±2%, and more preferably within an error range of ±1.5% from these electric current values. While the effect of the electromagnetic field treatment according to the present embodiment varies depending on the frequencies, the pronounced effect can be confirmed within a range of ±5%. As a method for measuring preferred frequencies, the frequencies may be measured while shifting the frequencies, and determined appropriately in accordance with the conditions for implementation in the electromagnetic field treatment according to the present embodiment.

TABLE 1

| | Magnetic | | |
|---|---|---|---|
| Frequency | Flux Density | Current (mA) at | Current (mA) at |
| (Hz) | (mG) | 454 (Turn/m) | 222 (Turn/m) |
| 74.75 | 2.3 | 0.38 | 0.77 |
| 102.5 | 3.0 | 0.50 | 1.01 |
| 151.5 | 5.3 | 0.89 | 1.8 |
| 205.0 | 7.1 | 1.18 | 2.4 |
| 222.5 | 7.4 | 1.23 | 2.5 |
| 301.0 | 10.4 | 1.72 | 3.5 |
| 345.0 | 12.3 | 2.07 | 4.2 |
| 466.0 | 16.3 | 2.71 | 5.5 |
| 484.0 | 17.3 | 2.85 | 5.8 |
| 655.0 | 23.5 | 3.89 | 7.9 |
| 954.0 | 31.9 | 5.26 | 10.7 |
| 1290.0 | 47.1 | 7.82 | 15.9 |
| 3500.0 | 130.6 | 21.89 | 44.5 |
| 4730.0 | 188.2 | 31.34 | 63.7 |
| 7000.0 | 323.3 | 54.30 | 110.4 |
| 9470.0 | 463.5 | 77.93 | 158.4 |
| 20000.0 | 1123.5 | 188.9 | 384.0 |
| 27000.0 | 1601.0 | 269.2 | 547.2 |
| 37300.0 | 2556.0 | 429.8 | 873.6 |
| 50400.0 | 3342.5 | 562.1 | 1142.4 |
| 80000.0 | 6039.0 | 1015.5 | 2064.0 |
| 108000.0 | 7302.9 | 1230.0 | 2500.0 |

Magnetic Flux Density (mG): Magnetic Flux Density (mG) (the following values, neighborhood values thereof, and integral multiples of these values)
Current (mA) at 454(Turn/m): Electric Current Value (mA) (coil turns: 454(Turn/m); the following values, neighborhood values thereof, and integral multiples of these values)
Current (mA) at 222(Turn/m): Electric Current Value (mA) (coil turns: 222 (Turn/m); the following values, neighborhood values thereof, and integral multiples of these values)

(Alternating Voltage-Alternating Electric Field)

Such an alternating voltage that satisfies the condition of having a high level at the rise time of the alternating magnetic field and having a low level at the fall time of the alternating magnetic field is used in the present embodiment.

The peak voltage of the alternating voltage according to the present embodiment is preferably higher than 50 mV. The peak voltage is more preferably 150 mV, and further preferably 1000 mV or higher. If this voltage is 50 mV or less, the treatment which is comparable to the case of a pulsed induced voltage in an electromagnetic field treatment through only the application of an alternating current to a coil will have a very small effect on the solvent characteristics of water.

When the tubes 101 and 201 through which water is run are large in diameter, the electromagnetic field treatment can be carried out efficiently by increasing the alternating voltage.

(Electromagnetically Treated Water)

The water to be subjected to the electromagnetic field treatment according to the present embodiment is not particularly limited, such as tap water and mineral water. The temperature of the water is also not particularly limited as long as the water is liquid.

The electromagnetic field treatment according to the present embodiment can be set up in any place such as near a main valve of a water pipe and near a faucet.

(Method for Evaluation of Solvent Characteristics)

The change in solvent characteristics of water was measured with the use of a solvent characteristic evaluation apparatus 300 in FIG. 5.

In this experimental apparatus, an experimental bath 310 is divided by partition plates 311A and 311B into three storage rooms 312, 313, and 314. The storage room 312 and the storage room 313 are connected through a water passing hole 319 of 7 mm. In this case, tap water at room temperature (approximately 20° C.) with a pH value of approximately 7, which has been passed through an ion-exchange resin, is used as water to be treated, in such way that this ion-exchanged water is circulated by a pump 315 provided in the middle of the tube 101 (201) through which water is run, in the order of the storage rooms 312, 313, and 314. In this case, the electromagnetic field treatment device 100 (200) is connected downstream of the pump 315. In addition, poorly-soluble calcium phosphate or magnesium phosphate 316 is placed in a powdered form on the bottom of the storage room 312, with the storage room 314 in communication with a water sampling pipe 317 through a valve 318.

The water treated in the electromagnetic field treatment device 100 (200), which flows into the storage room 312, is stored in the storage room 312. The powder of calcium phosphate or magnesium phosphate, which is placed in the storage room 312, is gradually dissolved by the water stored in the storage room 312, and flows through the water passing hole 319 into the storage room 313. When a certain amount of water flowing into the storage room 313 is stored, water flows into the storage room 314 from the top of the partition plate 311B. The water flowing into the storage room 314, with the help of the pump 315, passes through the electromagnetic field treatment device 100 (200), and again flows into the storage room 312.

It is to be noted that while the solvent characteristic evaluation apparatus 300 is used for evaluation in the present embodiment, the evaluation apparatus is not particularly limited as long as the apparatus has a configuration which can measure the effect of the electromagnetic field treatment on water.

The change in solvent characteristics through the electromagnetic field treatment was evaluated after carrying out this step for 2 hours with the use of 31 of water.

The solubility of the calcium phosphate or magnesium phosphate was measured by opening the valve 318 in FIG. 5, sampling 100 ml of the water from the water sampling pipe 317, and carrying out a titration with the use of silver nitrate.

In addition, also after 2 hours, a pH meter was placed before and after the electromagnetic field treatment apparatus 100 (200) to measure the difference in pH between before and after the electromagnetic field treatment apparatus 100 (200).

The following theory is conceivable as the reason for the change in solvent characteristics of water. Water is present while water molecules form clusters by hydrogen bonding. In this case, the implementation of the electromagnetic field treatment according to the present embodiment imparts rotational energy to these clusters. In this case, it is considered that it is difficult to impart effective rotational energy to the clusters unless an electromagnetic field is applied under special conditions. It is considered that the clusters with more energy stirs their neighborhood water molecules at the molecular level to develop solvent characteristics like water at a temperature higher than the temperature of the water, thus serving as water which is excellent in power for washing out stains.

The embodiments will be specifically described below with reference to examples. It is to be noted that the solubility of calcium phosphate in normal water is 0.027 mmol/l, whereas the solubility of magnesium phosphate in the water is 0.013 mmol/l.

### EXAMPLES

### Example 1

In Example 1, an electromagnetic field treatment device in such a similar form as in FIG. 2 was used for implementation in the solvent characteristic evaluation apparatus 300 in FIG. 5. A conductive copper foil adhesion tape 102 of 24 mm in width, 90 mm in length, and 0.09 mm in thickness was provided on a PVC pipe 101 of 17 mm in outside diameter and 15 mm in inside diameter in the length direction of the PVC pipe 101, and a vinyl tape 103 was wrapped so as to at least cover the conductive copper foil adhesion tape 102, thereby fixing and insulating the conductive copper foil adhesion tape 102. A conductive copper foil adhesion tape 104 of 100 mm in length and 0.09 mm in thickness was wrapped around the surface of the PVC pipe 101 wrapped with the vinyl tape 103, so as to at least cover the conductive copper foil adhesion tape 102. A VSF wire (core: strand wire, 3 mm) of 4.2 mm in diameter was wound around the PVC pipe 101 wrapped with the conductive copper foil adhesion tape 104 to provide a coil 106. The VSF wire was wound so as not to create any gaps. After winding the coil, the coil was fixed with a vinyl tape. Then, the coil was connected to an alternating current circuit, whereas the electrodes were connected to an alternating voltage circuit.

Pulse generation circuits were used for the alternating voltage and alternating magnetic field to have the same frequency out of phase with each other by 90° as in FIG. 4A. An alternating current of 1592.5 mA (63.7 mA×25) was applied to the coil at 4.5 kHz to 5.0 kHz, whereas an alternating voltage of ±5 V was applied to the electrodes at the same frequency as in the case of the alternating current. The circuit was regulated so that the alternating magnetic field had a rectangular wave with the rise time of and fall time of 0.1 μsec or less.

As for water, tap water at 20° C. was used, and passed through the electromagnetic field treatment device at a flow rate of 3 m/sec and with a flow quantity of 24 l/min.

After the electromagnetic field treatment, the solubility of calcium phosphate was measured.

### Comparative Example 1

The same applies as in Example 1, except that no alternating electric field was applied with the use of the electromagnetic field treatment device according to Example 1.

### Reference Example 1

The solubility of calcium phosphate in the ion exchanged tap water used in Example 1 was measured without applying the electromagnetic field treatment to the ion exchanged tap water.

As a result of Reference Example 1, the solubility of magnesium phosphate was 0.027 mmol/l.

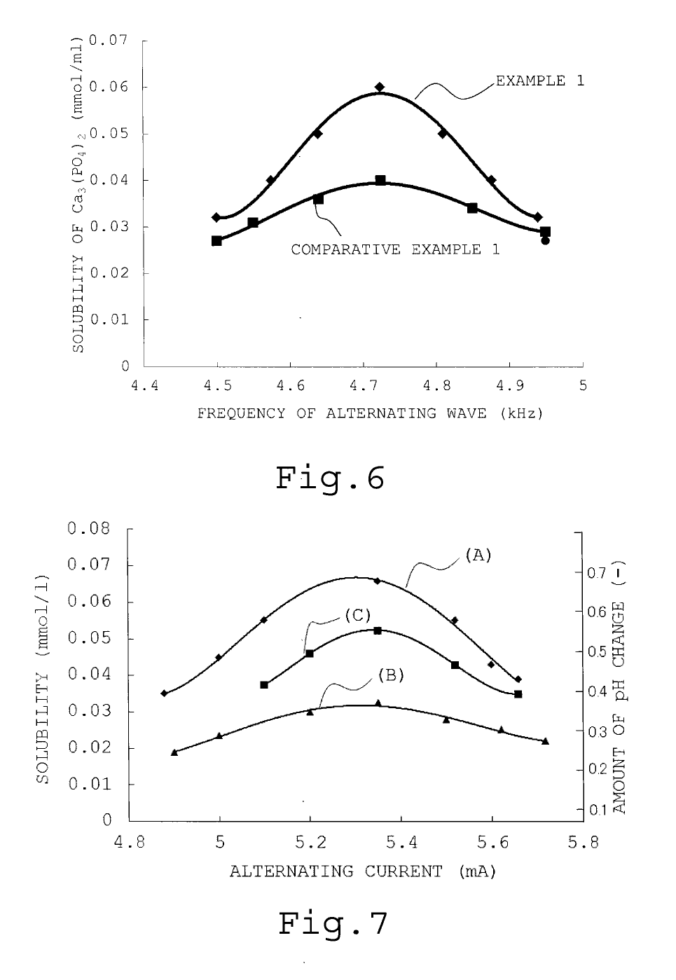

The graph of FIG. 6 shows the results of Example 1 and Comparative Example 1.

From the graph of FIG. 6, the effect of the alternating electric field on the solvent characteristics of water has been confirmed even at frequencies other than the specific frequencies.

Although the description as an example is omitted, the effect of applying an alternating electric field and an alternating magnetic field has been confirmed even at other frequencies.

### Example 2

The same applies as in Example 1, except that the (A) solubility of calcium phosphate, the (B) solubility of magnesium phosphate, and (C) the amount of change in pH for the electromagnetically treated water were measured with the frequencies fixed at 102 Hz and the alternating current varied from 4.7 mA to 5.8 mA.

The graph of FIG. 7 shows the result of Example 1.

From the graph of FIG. 7, the effect of applying an alternating electric field and an alternating magnetic field on the solvent characteristics of water has been confirmed even at magnetic flux densities other than specific magnetic flux densities.

Although the description as an example is omitted, similar changes in pH and tendency to improve the solvent characteristics have been confirmed even in other range of alternating current values.

It is to be noted that ΔpH has a negative value in each case (the same applies to the following examples and comparative examples).

### Example 3

This example is intended to confirm how solvent characteristics are changed with the energy of water increased by an electromagnetic field treatment.

The same applies as in Example 1, except that with the frequencies fixed at 3.492 kHz, an alternating current of 230 mA or 1.16 A was applied so that the magnetic flux density of the coil was 653.0 mG (130.6×5) or 3265 mG (130.6×25), to apply a electromagnetic field treatment to water at 20° C. to 50° C., and measure the change in pH and the solubility of the calcium phosphate.

### Comparative Example 2

The same applies as in Example 3, except that no alternating electric field was applied.

Tables 2 and 3 show the results of Example 3 and Comparative Example 2.

TABLE 2

ΔpH

| | 20° C. | 30° C. | 40° C. | 50° C. |
|---|---|---|---|---|
| Example 3-1 | 0.40 | 0.40 | 0.38 | 0.38 |
| Example 3-2 | 0.40 | 0.40 | 0.38 | 0.38 |
| Comparative | 0.30 | 0.15 | 0.00 | 0.00 |
| Example 2-1 | | | | |
| Comparative | 0.30 | 0.15 | 0.10 | 0.00 |
| Example 2-2 | | | | |

Example 3-1 (Magnetic Flux Density: 653 mG)
Example 3-2 (Magnetic Flux Density: 3265 mG)
Comparative Example 2-1 (Magnetic Flux Density: 653 mG)
Comparative Example 2-2 (Magnetic Flux Density: 3265 mG)

TABLE 3

Solubility of Ca₃(PO₄)₂ (mmol/l)

| | 20° C. | 30° C. | 40° C. | 50° C. |
|---|---|---|---|---|
| Example 3-1 | 0.049 | 0.049 | 0.047 | 0.047 |
| Example 3-2 | 0.049 | 0.048 | 0.047 | 0.047 |
| Comparative | 0.038 | 0.033 | 0.027 | 0.027 |
| Example 2-1 | | | | |
| Comparative | 0.038 | 0.033 | 0.027 | 0.027 |
| Example 2-2 | | | | |

Example 3-1 (Magnetic Flux Density: 653 mG)
Example 3-2 (Magnetic Flux Density: 3265 mG)
Comparative Example 2-1 (Magnetic Flux Density: 653 mG)
Comparative Example 2-2 (Magnetic Flux Density: 3265 mG)

From the results in Tables 2 and 3, the electromagnetic field treatments according to the examples achieved the large amounts of change in pH even for the high-temperature water, thereby resulting in increased effects of improvements in solvent characteristics. On the other hand, the electromagnetic field treatments according to the comparative examples caused rapid decreases in solubility of calcium phosphate, and decreases down to the same value as the solubility of untreated calcium phosphate at 40° C. or higher.

Although the description as an example is omitted, similar changes in pH and tendency to improve the solvent characteristics have been confirmed even with alternating current values or at other frequencies. The reason for these changes is considered to be that the energy of water increased by the electromagnetic field treatments according to the examples increases the number of collisions of water molecules to increase the concentration of H⁺ hydrogen ions, or increase the amounts of basic compounds and the like dissolved in the water. On the other hand, the treatment only with the magnetic field achieved a small increase in energy of water, thus resulting in a small amount of change in pH.

### Example 4

This example is intended to confirm how solvent characteristics are changed with the energy of water increased by an electromagnetic field treatment.

The same applies as in Example 1, except that the change in pH and the solubility of calcium phosphate were measured in such a way that the frequency of the alternating magnetic field of the coil was 3.492 kHz or 4.725 kHz, electromagnetic treatments were carried out with the rectangular waves in FIGS. 4A and 4B, and the magnetic flux density of the coil was 653 mG when the frequency was 3.492 kHz, and 941 mG when the frequency was 4.725 kHz.

Example 4-1 corresponds to the waveforms in FIG. 4A, whereas Example 4-2 corresponds to the waveforms in FIG. 4B.

### Comparative Example 3

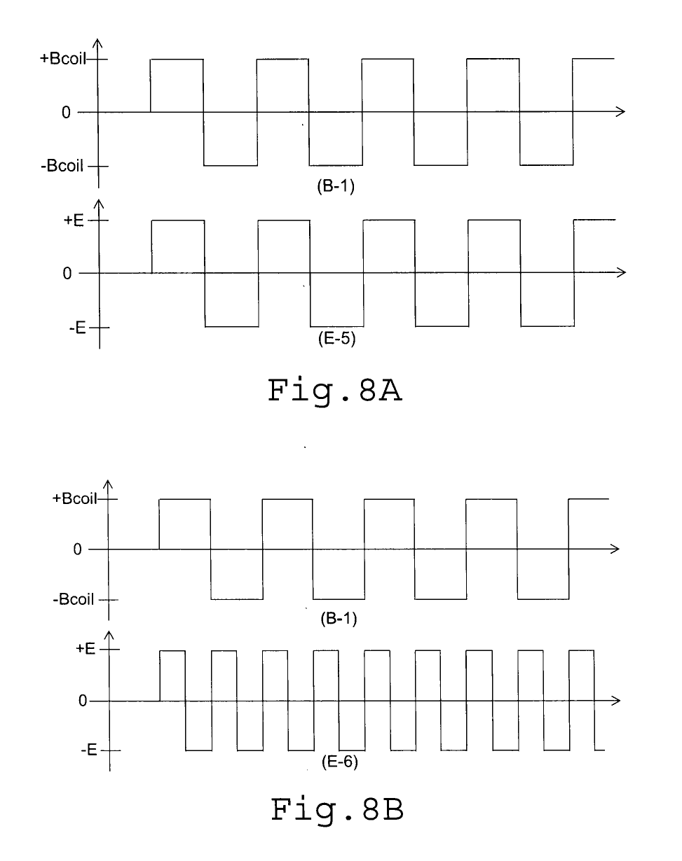

The same applies as in Example 4, except that an electromagnetic treatment was carried out only with an alternating magnetic field (B-1) without applying the rectangular waves in FIGS. 8A through 8C or the alternating electric field in FIG. 4A.

Comparative Example 3-1 corresponds to only the alternating magnetic field, Comparative Example 3-2 corresponds to the waveforms in FIG. 8A, Comparative Example 3-3 corresponds to the waveforms in FIG. 8B, and Comparative Example 3-4 corresponds to the waveforms in FIG. 8C.

The combinations of the alternating waves in the waveforms in FIGS. 8A to 8C all fail to satisfy the condition that the alternating voltage has a high level at the rise time of the alternating magnetic field, whereas the alternating voltage has a low level at the fall time of the alternating magnetic field.

The results of Example 4 and Comparative Example 3 are shown in Table 4 (alternating magnetic field frequency: 3.492 kHz) and Table 5 (alternating magnetic field frequency: 4.725 kHz).

TABLE 4

| | Alternating | Alternating | | |
|---|---|---|---|---|
| | Magnetic | Electric | | |
| | Field | Field | ΔpH | Solubility |
| Example4-1 | B-1 | E-1 | 0.50 | 0.050 |
| Example4-2 | B-1 | E-2 | 0.50 | 0.060 |
| Comparative | B-1 | none | 0.30 | 0.038 |
| Example 3-1 | | | | |
| Comparative | B-1 | E-5 | 0.20 | 0.033 |
| Example 3-2 | | | | |
| Comparative | B-1 | E-6 | 0.22 | 0.034 |
| Example 3-3 | | | | |
| Comparative | B-1 | E-7 | 0.14 | 0.034 |
| Example 3-4 | | | | |

Solubility: Solubility of Ca₃(PO₄)₂ (mmol/l)

TABLE 5

| | Alternating | Alternating | | |
|---|---|---|---|---|
| | Magnetic | Electric | | |
| | Field | Field | ΔpH | Solubility |
| Example 4-3 | B-1 | E-1 | 0.50 | 0.060 |
| Example 4-4 | B-1 | E-2 | 0.50 | 0.060 |
| Comparative | B-1 | none | 0.30 | 0.038 |
| Example 3-5 | | | | |
| Comparative | B-1 | E-5 | 0.20 | 0.033 |
| Example 3-6 | | | | |
| Comparative | B-1 | E-6 | 0.22 | 0.034 |
| Example 3-7 | | | | |
| Comparative | B-1 | E-7 | 0.15 | 0.034 |
| Example 3-8 | | | | |

Solubility: Solubility of Ca₃(PO₄)₂ (mmol/l)

From the results in Tables 4 and 5, only the satisfaction of the condition for the two rectangular waves achieved the effect of improving the solvent characteristics. The reason for these changes is considered to be that the energy of water increased by the electromagnetic field treatments according to the examples increases the number of collisions of water molecules to increase the concentration of hydrogen ions H⁺, or increase the amounts of basic compounds and the like dissolved in the water. On the other hand, the treatment only with the magnetic field achieved a small increase in energy of water, thus resulting in a small amount of change in pH.

### Example 5

### Comparative Example 4

The solubility of calcium phosphate, the solubility of magnesium phosphate, and the amount of change in pH of electromagnetically treated water were measured under the same conditions for implementation as in Example 1, except for implementation under the conditions in Table 6.

TABLE 6

| | | | Magnetic | | |
|---|---|---|---|---|---|
| | Frequency | Current | Field | Magnetic | Electric |
| | (Hz) | (A) | (mG) | Field | Field |
| Example5-1 | 4725 | 0.32 | 891 | B-2 | E-1 |
| Example5-2 | 4725 | 0.32 | 891 | B-3 | E-1 |
| Example5-3 | 3492 | 0.23 | 650 | B-2 | E-1 |
| Example5-4 | 3492 | 0.23 | 650 | B-3 | E-1 |
| Example5-5 | 102 | 0.11 | 327 | B-2 | E-1 |
| Example5-6 | 102 | 0.11 | 327 | B-3 | E-1 |
| Comparative | 4725 | 0.32 | 891 | B-2 | E-1 |
| Example 4-1 | | | | | |
| Comparative | 4725 | 0.32 | 891 | B-3 | E-1 |
| Example 4-2 | | | | | |
| Comparative | 3492 | 0.23 | 650 | B-2 | E-1 |
| Example 4-3 | | | | | |
| Comparative | 3492 | 0.23 | 650 | B-3 | E-1 |
| Example 4-4 | | | | | |
| Comparative | 102 | 0.11 | 327 | B-2 | E-1 |
| Example 4-5 | | | | | |
| Comparative | 102 | 0.11 | 327 | B-3 | E-1 |
| Example 4-6 | | | | | |

Current (A): Alternating Current (A)
Magnetic Field (mG): Alternating Magnetic Field (mG)
Magnetic Field: Alternating Magnetic Field
Electric Field: Alternating Electroc Field

### Example

### Comparative Example

Table 7 shows the results of Example 5 and Comparative Example 4.

TABLE 7

| | | Ca | Ma |
|---|---|---|---|
| | | Solubility | Solubility |
| | ΔpH | (mmol/l) | (mmol/l) |
| | E = ±5 V | | |
| Example 5-1 | 0.51 | 0.060 | 0.030 |
| Example 5-2 | 0.50 | 0.060 | 0.030 |
| Example 5-3 | 0.41 | 0.051 | 0.030 |
| Example 5-4 | 0.41 | 0.050 | 0.030 |
| Example 5-5 | 0.52 | 0.065 | 0.032 |
| Example 5-6 | 0.52 | 0.065 | 0.032 |
| | E = ±0.15 V | | |
| Example 5-1 | 0.50 | 0.059 | 0.030 |
| Example 5-2 | 0.50 | 0.058 | 0.030 |
| Example 5-3 | 0.41 | 0.050 | 0.029 |
| Example 5-4 | 0.40 | 0.050 | 0.028 |
| Example 5-5 | 0.51 | 0.063 | 0.032 |
| Example 5-6 | 0.51 | 0.063 | 0.032 |
| | E = ±0.05 V | | |
| Comparative | 0.12 | 0.028 | 0.014 |
| Example 4-1 | | | |
| Comparative | 0.10 | 0.028 | 0.013 |
| Example 4-2 | | | |
| Comparative | 0.10 | 0.029 | 0.015 |
| Example 4-3 | | | |
| Comparative | 0.10 | 0.029 | 0.014 |
| Example 4-4 | | | |
| Comparative | 0.12 | 0.029 | 0.015 |
| Example 4-5 | | | |
| Comparative | 0.12 | 0.029 | 0.014 |
| Example 4-6 | | | |

Ca Solubility: Solubility of Ca₃(PO₄)₂ (mmol/l)
Mg Solubility: Solubility of Mg₃(PO₄)₂ (mmol/l)

From the results in Table 7, the effect of the electromagnetic field treatment was hardly achieved at the alternating voltage of 50 mV or lower.

### Example 6

An alternating current of 100 mA was applied to a coil at 97 Hz to 108 Hz to carry out an electromagnetic field treatment in the same way as in Example 1, and measure (A) the solubility of calcium phosphate and (B) the amount of change in pH of electromagnetically treated water.

### Comparative Example 5

The same applies as in Example 6, except that (C) the solubility of calcium phosphate was measured without applying any alternating electric field.

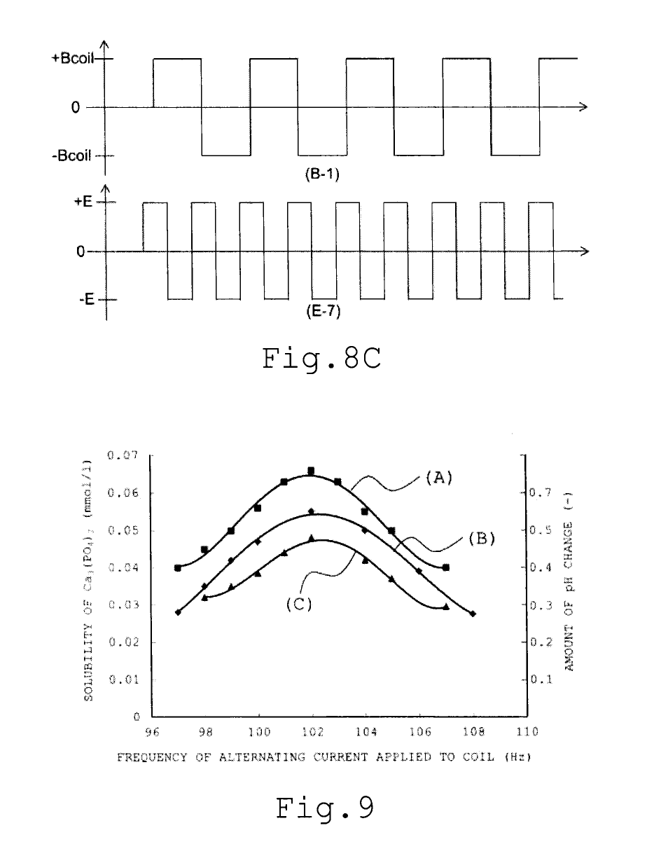

The graph of FIG. 9 shows the results of Example 6 and Comparative Example 5.

The treatment according to Comparative Example 5 achieved a smaller amount of change in solubility, as compared with the treatments according to the examples. Further, the water treated in Comparative Example 5 lost the effect of the treatment when the temperature of the water was increased to 30° C. degrees or more.

From the graph of FIG. 9, it has been confirmed that even at frequencies other than 102 Hz, the increased effect on the solvent characteristics of the water is achieved by the treatment of applying the alternating electric field and the alternating magnetic field, rather than the treatment of applying only the alternating magnetic field.

### Examples 7 and 8, Comparative Examples 6 and 7

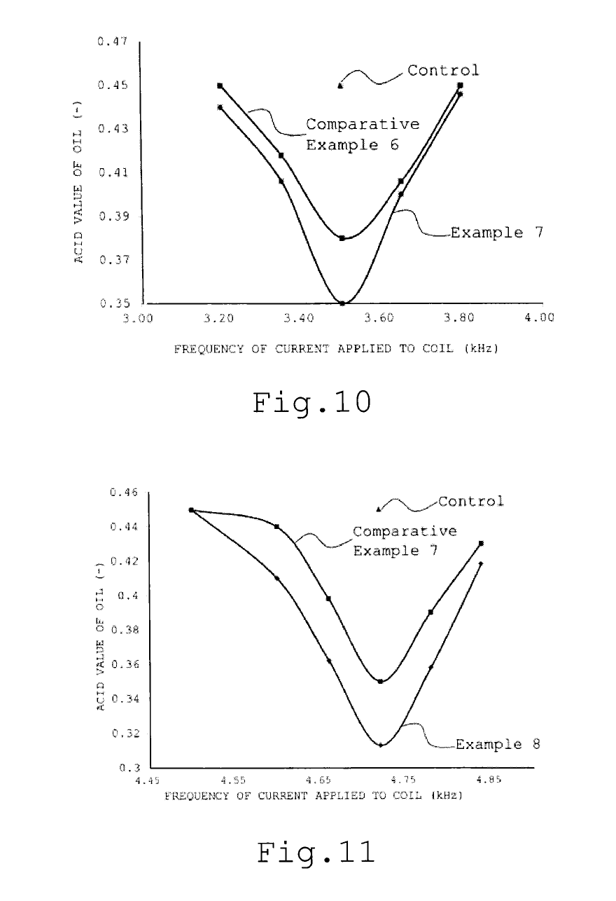

With the addition of 2 g of linseed oil, 100 ml of tap water at water temperature of 29° C., which was subjected to an electromagnetic field treatment under the conditions in Table 8, was boiled for 1 hour and 40 minutes. After the boiling treatment, dewatering was carried out to collect the oil. The collected oil was dissolved in a solvent of ethanol and diethyl ether, and titrated with a standard solution of potassium hydroxide to measure the acid value of the treated oil. FIGS. 10 and 11 show the results of measuring the acid value. It is to be noted that a VSF wire of 2.2 mm in diameter was used for coil winding, and the number of turns was adjusted to 454 (Turn/m). The acid value of the linseed oil used in the examples was 0.07 before the heating, and 0.45 after the heat treatment.

TABLE 8

| | Frequency | Current | Voltage | | |
|---|---|---|---|---|---|
| | (kHz) | (mA) | (V) | Current | Voltage |
| Example 7-1 | 3.20 | 620 | ±5 | E-1 | B-2 |
| Example 7-2 | 3.35 | 620 | ±5 | E-1 | B-2 |
| Example 7-3 | 3.50 | 620 | ±5 | E-1 | B-2 |
| Example 7-4 | 3.65 | 620 | ±5 | E-1 | B-2 |
| Example 7-5 | 3.80 | 620 | ±5 | E-1 | B-2 |
| Comparative | 3.20 | 620 | 0 | none | B-2 |
| Example 6-1 | | | | | |
| Comparative | 3.35 | 620 | 0 | none | B-2 |
| Example 6-2 | | | | | |
| Comparative | 3.50 | 620 | 0 | none | B-2 |
| Example 6-3 | | | | | |
| Comparative | 3.65 | 620 | 0 | none | B-2 |
| Example 6-4 | | | | | |
| Comparative | 3.80 | 620 | 0 | none | B-2 |
| Example 6-5 | | | | | |
| Example 8-1 | 4.50 | 620 | ±5 | E-1 | B-2 |
| Example 8-2 | 4.60 | 620 | ±5 | E-1 | B-2 |
| Example 8-3 | 4.66 | 620 | ±5 | E-1 | B-2 |
| Example 8-4 | 4.72 | 620 | ±5 | E-1 | B-2 |
| Example 8-5 | 4.78 | 620 | ±5 | E-1 | B-2 |
| Example 8-6 | 4.84 | 620 | ±5 | E-1 | B-2 |
| Comparative | 4.50 | 620 | 0 | none | B-2 |
| Example 7-1 | | | | | |
| Comparative | 4.60 | 620 | 0 | none | B-2 |
| Example 7-2 | | | | | |
| Comparative | 4.66 | 620 | 0 | none | B-2 |
| Example 7-3 | | | | | |
| Comparative | 4.72 | 620 | 0 | none | B-2 |
| Example 7-4 | | | | | |
| Comparative | 4.78 | 620 | 0 | none | B-2 |
| Example 7-5 | | | | | |
| Comparative | 4.84 | 620 | 0 | none | B-2 |
| Example 7-6 | | | | | |

Frequency (kHz): Frequency of Current Applied to Coil (kHz)
Current (mA): Value of Current Applied to Coil (mA)
Voltage (V): Voltage Value of Accelerating Voltage (V)
Current: Waveform of Current in Alternating Magnetic Field
Voltage: Waveform of Voltage in Alternating Electric Field

The acid values in the examples were lower at each of the frequencies as compared with the acid values in the comparative examples. More specifically, it has been determined that the oil oxidation by heating is suppressed by the electromagnetic field treatment, rather than by only the magnetic field treatment. It is to be noted that differences from particularly favorable frequencies will decrease the effect of the magnetic field treatment or electromagnetic field treatment to come closer to the value of the control. This is expected to be used for electromagnetic cookers, etc. to apply the electromagnetic field treatment to oil itself containing water in a minute amount, suppress the oil oxidation, and make the oil exchange cycle longer.

### Examples 9 and 10

### Comparative Examples 8 and 9

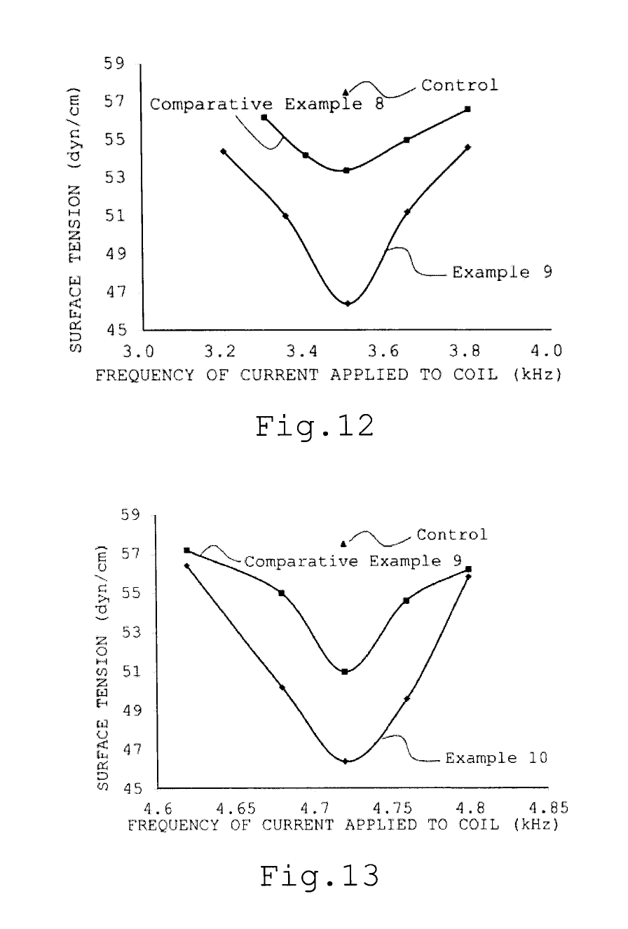

Sodium hexadecyl sulfate was dissolved for 1.2×10⁻⁴ mol/l in ion-exchange water at a water temperature of 29° C., which was subjected to an electromagnetic field treatment under the conditions in Table 9, and after 1 hour, the height of the water rising in a capillary tube of 1.2 mm in inside diameter was measured to measure the surface tension. It is to be noted that a VSF wire of 2.2 mm in diameter was used for coil winding, and the number of turns was adjusted to 454 (Turn/m). The water rises to a height of 22 mm in the case of the capillary tube of 1.2 mm in inside diameter, which corresponds to 72.5 dyn/cm. FIGS. 12 and 13 show the results of measuring the surface tension of the water subjected to the electromagnetic field treatment or magnetic field treatment, with the surface tension of water as a reference. It is to be noted that the surface tension was 57.5 dyn/cm when the same concentration of sodium hexadecyl sulfate was dissolved in water subjected to no electromagnetic treatment (control).

TABLE 9

| | Frequency | Current | Voltage | | |
|---|---|---|---|---|---|
| | (kHz) | (mA) | (V) | Current | Voltage |
| Example 9-1 | 3.20 | 620 | ±5 | E-1 | B-2 |
| Example 9-2 | 3.35 | 620 | ±5 | E-1 | B-2 |
| Example 9-3 | 3.50 | 620 | ±5 | E-1 | B-2 |
| Example 9-4 | 3.65 | 620 | ±5 | E-1 | B-2 |
| Example 9-5 | 3.80 | 620 | ±5 | E-1 | B-2 |
| Comparative | 3.30 | 620 | 0 | none | B-2 |
| Example 8-1 | | | | | |
| Comparative | 3.40 | 620 | 0 | none | B-2 |
| Example 8-2 | | | | | |
| Comparative | 3.50 | 620 | 0 | none | B-2 |
| Example 8-3 | | | | | |
| Comparative | 3.65 | 620 | 0 | none | B-2 |
| Example 8-4 | | | | | |
| Comparative | 3.80 | 620 | 0 | none | B-2 |
| Example 8-5 | | | | | |
| Example 10-1 | 4.62 | 620 | ±5 | E-1 | B-2 |
| Example 10-2 | 4.68 | 620 | ±5 | E-1 | B-2 |
| Example 10-3 | 4.72 | 620 | ±5 | E-1 | B-2 |
| Example 10-4 | 4.76 | 620 | ±5 | E-1 | B-2 |
| Example 10-5 | 4.80 | 620 | ±5 | E-1 | B-2 |
| Comparative | 4.62 | 620 | 0 | none | B-2 |
| Example 9-1 | | | | | |
| Comparative | 4.68 | 620 | 0 | none | B-2 |
| Example 9-2 | | | | | |
| Comparative | 4.72 | 620 | 0 | none | B-2 |
| Example 9-3 | | | | | |
| Comparative | 4.76 | 620 | 0 | none | B-2 |
| Example 9-4 | | | | | |
| Comparative | 4.80 | 620 | 0 | none | B-2 |
| Example 9-5 | | | | | |

Frequency (kHz): Frequency of Current Applied to Coil (kHz)
Current (mA): Value of Current Applied to Coil (mA)
Voltage (V): Voltage Value of Accelerating Voltage (V)
Current: Waveform of Current in Alternating Electric Field
Voltage: Waveform of Voltage in Alternating Magnetic Field

The surface tensions in the examples were lower at each of the frequencies, as compared with the surface tensions in the comparative examples. More specifically, the decrease in surface tension was made remarkable at particularly favorable frequencies by the electromagnetic field treatment, rather than by only the magnetic field treatment. It is to be noted that differences from particularly favorable frequencies will decrease the effect of the magnetic field treatment or electromagnetic field treatment to come closer to the value of the control. A significant decrease in surface tension, which was achieved by the electromagnetic field treatment, was confirmed by just adding a slight amount of surfactant.

This indicates that the hydrogen bonding strength of the water solvent is reduced by the electromagnetic field treatment according to the present embodiment. The reduced hydrogen bonding strength is considered to affect the strength of hydrated solids when calcium carbonate, magnesium carbonate, etc. are bound to water molecules to produce the solids.

The embodiments are, by way of example, not to be considered limited to the above description. Modification examples such as configuration changes, modifications, omissions, and additions can be implemented without departing from the spirit of the disclosure.

What is claimed is:

1. An electromagnetic field treatment method for water,
the method comprising: applying, to water, an alternating magnetic field generated by applying an alternating current to a coil, and applying, to the water, an alternating electric field generated by applying an alternating voltage in synchronization with the alternating magnetic field to an electrode, wherein
the alternating current and voltage has a rectangular alternating current wave, and
the alternating voltage at rise time of an alternating wave of the alternating magnetic field has a high level, whereas the alternating voltage at fall time of the alternating wave of the alternating magnetic field has a low level, or the alternating voltage at the rise time of the alternating magnetic field has a low level, whereas the alternating voltage at the fall time of the alternating magnetic field has a high level.

2. The electromagnetic field treatment method for water according to claim 1, wherein the alternating current wave of the alternating current has any frequency from a group of frequencies of 74.75 Hz, 102.5 Hz, 151.5 Hz, 205.0 Hz, 222.5 Hz, 301.0 Hz, 345.0 Hz, 466.0 Hz, 484 Hz, 655 Hz, 954 Hz, 1.29 kHz, 3.5 kHz, 4.73 kHz, 7.0 kHz, 9.47 kHz, 20.0 kHz, 27.0 kHz, 37.3 kHz, 50.4 kHz, 80.0 kHz, and 108.0 kHz, or within ±5% of any of these frequencies.

3. The electromagnetic field treatment method for water according to claim 1, wherein the alternating current wave of the alternating current has any frequency from a group of frequencies of 74.75 Hz, 102.5 Hz, 151.5 Hz, 205.0 Hz, 222.5 Hz, 301.0 Hz, 345.0 Hz, 466.0 Hz, 484 Hz, 655 Hz, 954 Hz, 1.29 kHz, 3.5 kHz, 4.73 kHz, 7.0 kHz, 9.47 kHz, 20.0 kHz, 27.0 kHz, 37.3 kHz, 50.4 kHz, 80.0 kHz, and 108.0 kHz, or within ±2% of any of these frequencies.

4. The electromagnetic field treatment method according to claim 1, wherein the alternating magnetic field and the alternating electric field are orthogonal to each other.

5. The electromagnetic field treatment method according to claim 3, wherein the alternating electric field has a frequency which is an odd multiple of the alternating magnetic field.

6. An electromagnetic field treatment device for water, the device at least comprising:
a tube through which water is run;
a positive electrode provided on a surface of the tube;
a first insulating material covering at least the positive electrode;
a negative electrode provided on a surface of the tube or the first insulating material;
a coil wound around at least the negative electrode; and
an external circuit connected to the positive electrode and the negative electrode as well as the coil,
wherein the external circuit is designed to apply an alternating magnetic field and an alternating electric field in synchronization with the alternating magnetic field to the inside of the tube.

7. The electromagnetic field treatment device for water according to claim 6, wherein the tube through which water is run is a dielectric tube.

8. The electromagnetic field treatment device according to claim 6, wherein the alternating current wave of the alternating current has any frequency from a group of frequencies of 74.75 Hz, 102.5 Hz, 151.5 Hz, 205.0 Hz, 222.5 Hz, 301.0 Hz, 345.0 Hz, 466.0 Hz, 484 Hz, 655 Hz, 954 Hz, 1.29 kHz, 3.5 kHz, 4.73 kHz, 7.0 kHz, 9.47 kHz, 20.0 kHz, 27.0 kHz, 37.3 kHz, 50.4 kHz, 80.0 kHz, and 108.0 kHz, or within ±5% of any of these frequencies.

9. The electromagnetic field treatment device according to claim 6, wherein the alternating current wave of the alternating current has any frequency from a group of frequencies of 74.75 Hz, 102.5 Hz, 151.5 Hz, 205.0 Hz, 222.5 Hz, 301.0 Hz, 345.0 Hz, 466.0 Hz, 484 Hz, 655 Hz, 954 Hz, 1.29 kHz, 3.5 kHz, 4.73 kHz, 7.0 kHz, 9.47 kHz, 20.0 kHz, 27.0 kHz, 37.3 kHz, 50.4 kHz, 80.0 kHz, and 108.0 kHz, or within ±2% of any of these frequencies.

10. The electromagnetic field treatment device according to claim 6, wherein the alternating magnetic field and the alternating electric field are orthogonal to each other.

11. The electromagnetic field treatment device according to claim 8, wherein the alternating electric field has a frequency which is an odd multiple of the alternating magnetic field.

12. An electromagnetic field treatment device comprising:
a magnetic field application unit configured to apply an alternating magnetic field to water; and
an electric field application unit configured to apply an alternating electric field in synchronization with the alternating magnetic field to the water, wherein
the alternating current and voltage has a rectangular alternating wave, and
the alternating voltage at rise time of the alternating magnetic field has a high level, whereas the alternating voltage at fall time of the alternating magnetic field has a low level, or the alternating voltage at the rise time of the alternating magnetic field has a low level, whereas the alternating voltage at the fall time of the alternating magnetic field has a high level.

13. The electromagnetic field treatment device according to claim 12, wherein the alternating current wave of the alternating current has any frequency from a group of frequencies of 74.75 Hz, 102.5 Hz, 151.5 Hz, 205.0 Hz, 222.5 Hz, 301.0 Hz, 345.0 Hz, 466.0 Hz, 484 Hz, 655 Hz, 954 Hz, 1.29 kHz, 3.5 kHz, 4.73 kHz, 7.0 kHz, 9.47 kHz, 20.0 kHz, 27.0 kHz, 37.3 kHz, 50.4 kHz, 80.0 kHz, and 108.0 kHz, or within ±5% of any of these frequencies.

14. The electromagnetic field treatment device according to claim 12, wherein the alternating current wave of the alternating current has any frequency from a group of frequencies of 74.75 Hz, 102.5 Hz, 151.5 Hz, 205.0 Hz, 222.5 Hz, 301.0 Hz, 345.0 Hz, 466.0 Hz, 484 Hz, 655 Hz, 954 Hz, 1.29 kHz, 3.5 kHz, 4.73 kHz, 7.0 kHz, 9.47 kHz, 20.0 kHz, 27.0 kHz, 37.3 kHz, 50.4 kHz, 80.0 kHz, and 108.0 kHz, or within ±2% of any of these frequencies.

15. The electromagnetic field treatment device according to claim 12, wherein the alternating magnetic field and the alternating electric field are orthogonal to each other.

16. The electromagnetic field treatment device according to claim 13, wherein the alternating electric field has a frequency which is an odd multiple of the alternating magnetic field.
